(19) United States
(12) Patent Application Publication
(10) Pub. No.: US 2019/0225898 A1
(43) Pub. Date: Jul. 25, 2019

(54) RAW GAS QUENCHING SYSTEM

(71) Applicant: Siemens Aktiengesellschaft, Munich (DE)

(72) Inventors: Tino Just, Freiberg (DE); Friedemann Mehlhose, Freiberg (DE); Darek Schmauch, Brotterode-Trusetal (DE); Andreas Meissner, Trebsen / Mulde (DE); Ralph Schumann, Markkleeberg (DE)

(73) Assignee: Siemens Aktiengesellschaft, Munich (DE)

(21) Appl. No.: 16/336,559

(22) PCT Filed: Sep. 12, 2017
(86) PCT No.: PCT/EP2017/072798

§ 371 Date: Mar. 26, 2019

(30) Foreign Application Priority Data
Sep. 29, 2016 (DE) 10 2016 218 855.0

(51) Int. Cl. C10J 3/84; C10J 3/48; B01D 47/06

(52) U.S. Cl. CPC C10J 3/845; B01D 47/06; C10J 3/485

(57) ABSTRACT

A raw gas washing system with a high degree of deposition of dust in an entrained flow gasification device for the conversion of ash-containing fuels by a gasification device containing free oxygen into a raw gas with a high proportion of hydrogen, in which the fuel is converted in a gasification reactor at temperatures of between 1200 and 1900° C. and method pressures of up to 10 MPa into raw gas and liquid slag. A quenching space designed as a free-space quench contains an additional washing ring which causes a direct-current washing of the quenched raw gas, reducing the particle loading of the raw gas in the raw gas output, thereby reducing subsequent raw gas purification steps.

### CROSS REFERENCE TO RELATED APPLICATIONS

This application is the US National Stage of International Application No. PCT/EP2017/072798 filed Sep. 12, 2017, and claims the benefit thereof. The International Application claims the benefit of German Application No. DE 10 2016 218 855.0 filed Sep. 29, 2016. All of the applications are incorporated by reference herein in their entirety.

### FIELD OF INVENTION

The invention relates to a raw gas scrubbing system in an entrained flow gasification unit for the reaction of ash-containing fuels with a free oxygen-containing gasifying composition to give a raw gas having a high hydrogen content, in which the fuel is converted in a gasification reactor at temperatures of 1200 to 1900° C. and process pressures up to 10 MPa to raw gas and liquid slag.

The invention relates to an apparatus for quenching and cleaning of raw gas from an entrained flow gasifier, in which a quench space is disposed within a pressure shell beneath a reaction space, a guide tube that guides the raw gas from the reaction space into the quench space projects into the quench space, and the quench space, above a quencher bottom, has a raw gas outlet that passes through the pressure shell.

### BACKGROUND OF INVENTION

Entrained flow gasification is used for the gasification of various hydrocarbonaceous fuels. The reactors used consist of two spaces. In the upper portion, the fuel is gasified and, if present, the ash is melted. The hot raw gas is fed to the second space (quencher) together with the liquid slag. With injection of water, as well as the cooling of the raw gas, abrupt solidification of the slag takes place. The intended cooling of the raw gas to saturation temperature is referred to as full quenching. The required amount of quenching water is charged with a safety factor in order to prevent the breakthrough of hot crude gas into the crude gas exit.

In the case of clear-space quenching, coarse-grain particles, lumps of slag and large amounts of fine dust are entrained into the raw gas exit. The downstream plants are impaired by fine dust in particular.

In the case of clear-space quenching, water is injected into the raw gas stream via quenching nozzles. This cools the hot raw gas down to its saturation temperature. In this operation, the slag melted in the reactor solidifies and falls into a water bath in the bottom of the quencher. The raw gas is then deflected and leaves the reactor via the raw gas exit. Coarse particles can be scrubbed out as well by the residual quenching water (from the excess through use of a safety factor). The deflection and associated acceleration of the raw gas immediately upstream of the raw gas exit results in entrainment of droplets and particles.

Patent document DE102013218830.7 proposed a quencher with integrated scrubbing, which can also be referred to as scrubber quench. The internals specified, especially the cooled region of the central tube, are complex.

As well as clear-space quenching and the scrubber quench, there is immersed quenching, where the raw gas is immersed with the aid of an inserted tube into a water bath in the quencher bottom, deflected and sent to the raw gas outlet. The gas is first cooled down to saturation temperature in the water bath. Coarse particles and the slag are supposed to be removed from the raw gas by the immersion in the water bath. In the immersed tube, owing to the direct contact between water film and hot crude gas, there is partial cooling of the raw gas.

### SUMMARY OF INVENTION

It is an object of the invention to configure a quencher for an entrained flow gasifier that firstly effectively cools the raw gas and, on departure from the quencher, has a considerably reduced burden of particles and, secondly, the quencher can be operated reliably.

The problem is solved by a quencher having the features of the independent claim.

According to the invention, the quench tube 4 and the central tube 8 are executed as a twin shell. Thus, both components can be executed with cooling. Production of low complexity, by comparison with coiled components (cooling with pipe coils), is thus possible.

Burnout of the quench tube and central tube is prevented by the flow of cooling water through the twin shell.

In the case of variants 1 to 3, the use of quenching and scrubbing water as cooling medium means that very large amounts of water are available, by means of which very good component cooling can be ensured. Damage to the tube can be detected via the process control. If damage to the tube occurs, water escapes from the immersed tube through it. The nozzle characteristic is recorded in the process control, which means that the pressure differential that exists between the twin shell and the quench and the mass flow rate that flows through the quenching nozzles are known. If there is damage to the quench tube, there will be a decrease in the pressure differential, with a simultaneous increase in the mass throughput.

In the case of variants 4 and 5, damage to the central tube can be detected very easily. If the tube is damaged in variant 4, the water runs via the damage out of the tube. The amount of water to be replenished increases, which is detected by measurement technology. In the case of variant 5, damage to the central tube can be detected by the differential of inflow and backflow rate.

The cooling of the internals, especially in variants 1-3, decreases the thermal stress on the materials. It is thus possible to use inexpensive materials.

The quenching water in variants 1 to 3 functions as quenching water and as cooling water for the quench tube. Thus, an additional function is assigned to the quenching water. The gain lies in additional component cooling without having to extend existing cooling systems.

The quenching water is conditioned, especially with regard to solids content and content of dissolved carbonates.

The quenching device of the invention has low water consumption based on the quenching effect.

The described concept of a cooled central tube in the quencher can be applied to the higher-power reactors (greater than 500 MW).

After the quenching in the tube, immersion in the water bath is possible (shown in FIG. 3 depending on the plant design); downstream countercurrent scrubbing in the outer ring space is achievable.

A conventionally arranged skirt with all the measurement technology can be dispensed with.

In the quenching unit of the invention, integration of the monitoring into existing measurement and control technology of the quenching water circuit is possible.

Advantageous developments of the invention are specified in the dependent claims.

### BRIEF DESCRIPTION OF THE DRAWINGS

The invention is elucidated in detail hereinafter as a working example in a scope required for understanding with reference to figures. The figures show:

FIG. 1 as variant 1 a clear-space quench with a closed, self-cooling central tube,

FIG. 2 detail A from FIG. 1,

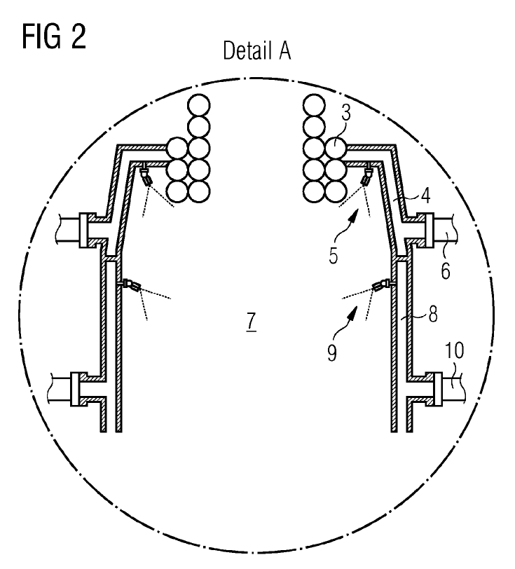

FIG. 3 as variant 2 a clear-space quench with a closed, self-cooling central tube,

FIG. 4 detail A from FIG. 3,

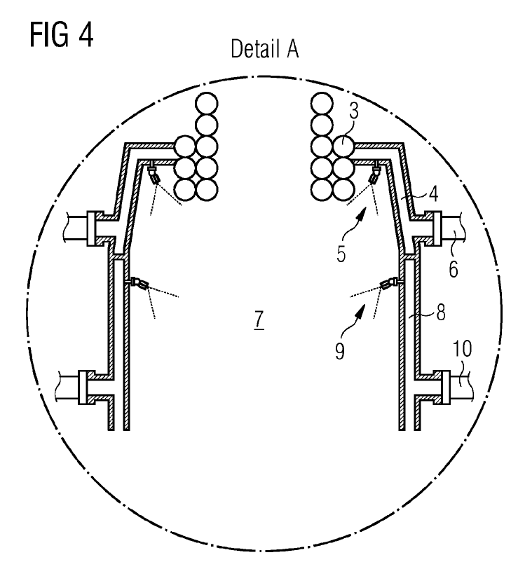

FIG. 5 as variant 3 a clear-space quench with an open, cooling central tube,

FIG. 6 detail A from FIG. 5,

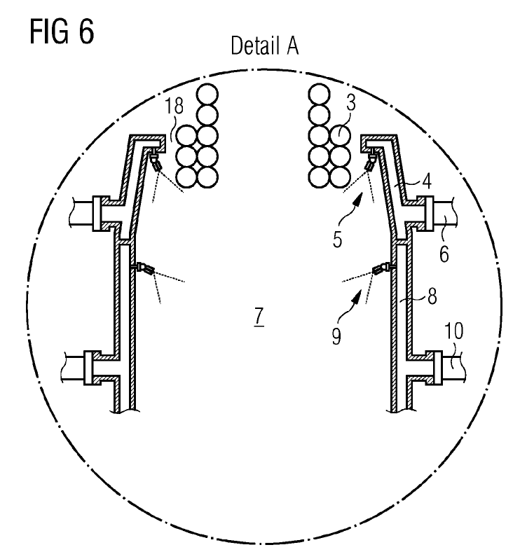

FIG. 7 as variant 4 a clear-space quench with a self-contained, cooling central tube,

FIG. 8 detail A from FIG. 7,

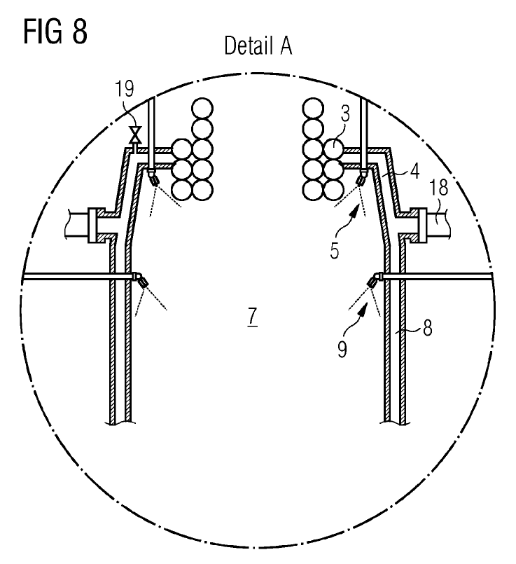

FIG. 9 as variant 5 a clear-space quench with a self-contained central tube and flow cooling, and

FIG. 10 detail A from FIG. 9.

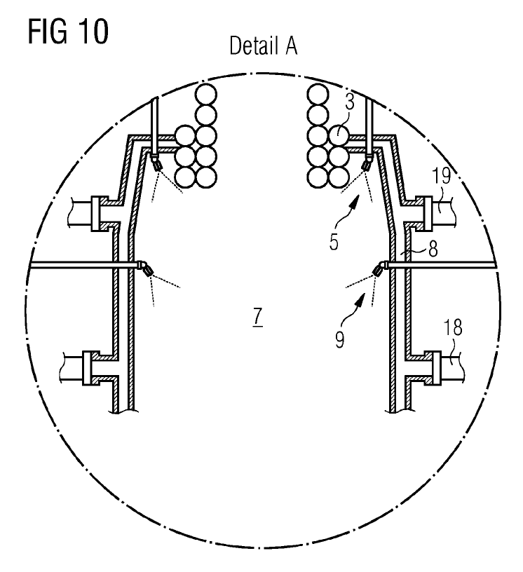

### DETAILED DESCRIPTION OF INVENTION

Quenching in the tube with a configuration of the central tube of low complexity is described. For the execution of the tube quenching, 5 variants for a cooled central tube are shown. The quenching is followed by additional scrubbing stages.

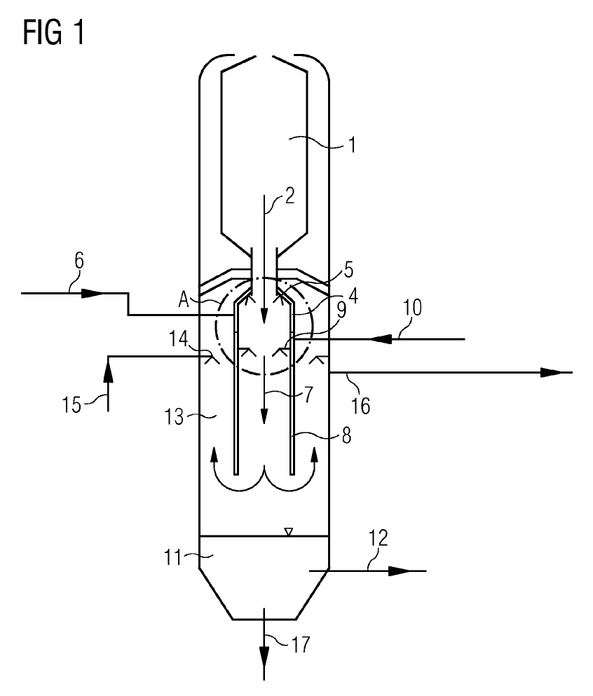

Variant 1 is shown in FIG. 1. The hot raw gas and the molten slag are guided out of the reactor (1) via the slag drain body (3) into the quench zone (7). The quench zone (7) is bounded by a centrally installed tube (4, 8). This tube consists of the cooled quench tube (4) and the cooled central tube (8). The quench tube may have a conical design. In variant 1, the cooled quench tube (4) has a gastight connection to the slag drain body (3). The quench tube (4) and the central tube (8) have a twin shell. In the intermediate space there is water for cooling of the shell, especially for the side that bounds the quench zone (7). The quenching nozzles (5) are screw-mounted in the quench tube (4). They are supplied via the interspace, water shell of the quench tube (4). Thus, large amounts of water are available for the cooling of the quench tube without requiring a new water source. The quenching water (6) is thus assigned a new function in the form of the cooling of the quench tube. The quenching water (6) is supplied via the quenching nozzles (5) to the quench zone (7) and ensures full quenching in the central tube (8). In order to achieve reliable full quenching, the quenching water is charged with a safety factor. The hot liquid slag solidifies completely during the quenching.

The central tube (8) is likewise cooled via the interspace, water shell. The water used for cooling is then injected into the quench zone (7) via the scrubbing nozzles of the central tube (9). Thus, sufficient purging of the central tube is ensured, in order that deposits and blockages are prevented. The fully quenched raw gas leaves the central tube (9), is deflected and flows within the outer ring space (13) in the direction of raw gas exit (16). Additional scrubbing apparatuses (illustrated here by countercurrent scrubbers, 14 and 15) may be installed in the outer ring space (13). The raw gas leaves the reactor via the raw gas exit (16). The solidified slag, the residual quenching water obtained (from 6) and the scrubbing water (10) from the central tube (8) and the scrubbing water (15) optionally injected in the ring space (13) collect in the water bath in the quencher bottom (11). This water is drawn off into the flash system (12). The slag is fed together with a portion of the water from the quencher bottom (11) via the slag exit (17) to the downstream slag outlet system.

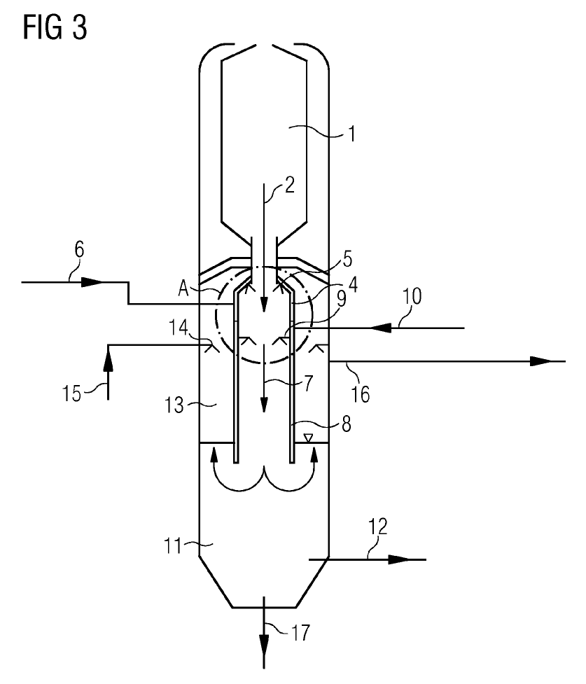

Variant 2 is shown in FIG. 3. In variant 2, the cooled central tube (8) (of identical design to variant 1) is immersed in the water bath in the quencher bottom (11). The raw gas fully quenched in the central tube (8) is deflected in the water bath and ascends to the water surface in the outer ring space (13). As a result of the immersion, the raw gas undergoes scrubbing. A countercurrent scrubber (14, 15) may be installed in the ring space (13). The solidified slag, the residual quenching water obtained from (6), and the scrubbing water (10) from the central tube (8) and the scrubbing water (15) optionally injected in the ring space (13) collect in the water bath in the quencher bottom (11). This water is drawn off (12) into the flash system.

The slag together with a portion of the water (which is not drawn off into the flash system) from the quencher bottom (11) is fed via the slag exit (17) to the downstream slag discharge system.

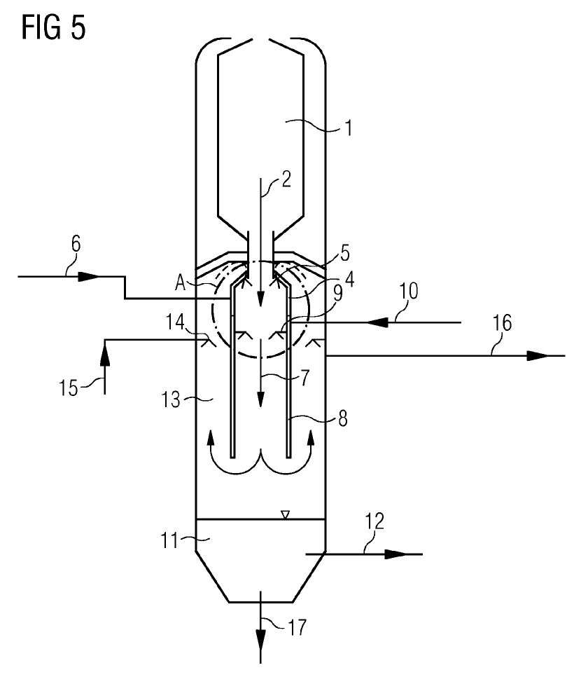

FIG. 5 shows variant 3 having a cooled quench tube and central tube (4, 8). The mode of function corresponds to variant 1. By contrast with variant 1, the quench tube (4) is not secured gastight to the slag drain body (3). There exists a defined gap (18) between the slag drain body (3) and the quench tube (4). Cold, saturated raw gas flows from the outer ring space (13) through this gap (18) into the quench tube. Thus, the upper region of the quench tube (4) is additionally cooled with cold gas, but the flow of the cold gas prevents hot raw gas from collecting behind the quenching nozzles (5). The risk of damage to the quenching nozzles (5) and to the upper quench tube (4) is reduced.

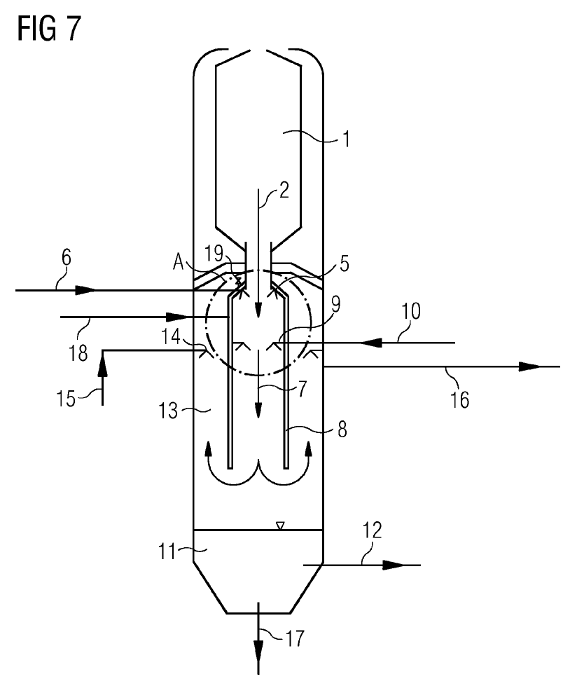

Variant 4 is shown in FIG. 7. The hot raw gas and the molten slag are guided from the reactor (1) via the slag drain body (3) into the quench zone (7). The quench zone (7) is bounded by the central tube (8). The latter has a twin shell completely filled with water. This water ensures reliable cooling of the central tube. The cooling is ensured by heating and partial evaporation of the cooling water. The vapor formed in the central space is discharged via an outlet valve (19) into the outer ring space (13) and passes into the raw gas. The losses of cooling water are compensated for by replenishment (18) with fresh cooling water. The evaporation of the cooling water in the central tube requires large amounts of energy. For this reason, the cooling water demand for the central tube can be minimized. Damage to the central tube can be detected easily. In the event of damage, the amount of water to be replenished increases abruptly. In the upper region of the central tube are the quenching nozzles (5). Below that are disposed the scrubbing nozzles (9). The quenching nozzles and the scrubbing nozzles are supplied via separate conduits (6, 10). Full quenching in the central tube (8) is ensured. In order to achieve this, the amount of quenching water is charged with a safety factor. The hot liquid slag solidifies completely during the quenching. The scrubbing nozzles ensure sufficient purging of the central tube (8), which means that deposits and blockages are prevented. The fully quenched raw gas leaves the central tube (9), is deflected and flows within the outer ring space (13) in the direction of raw gas exit (16). Additional scrubbing apparatuses (illustrated here by countercurrent scrubbers, 14 and 15) may be installed in the outer ring space. The raw gas leaves the reactor via the raw gas exit (16). The solidified slag, the residual quenching water obtained (from the quenching water 6) and the scrubbing water (10) from the central tube (8) and the scrubbing water (15) optionally injected in the ring space (13) collect in the water bath in the quencher bottom (11). To control the fill level, water is drawn off (12) into a flash system. The slag is fed together with a portion of the water from the quencher bottom (11) via the slag exit (17) to the downstream slag outlet system.

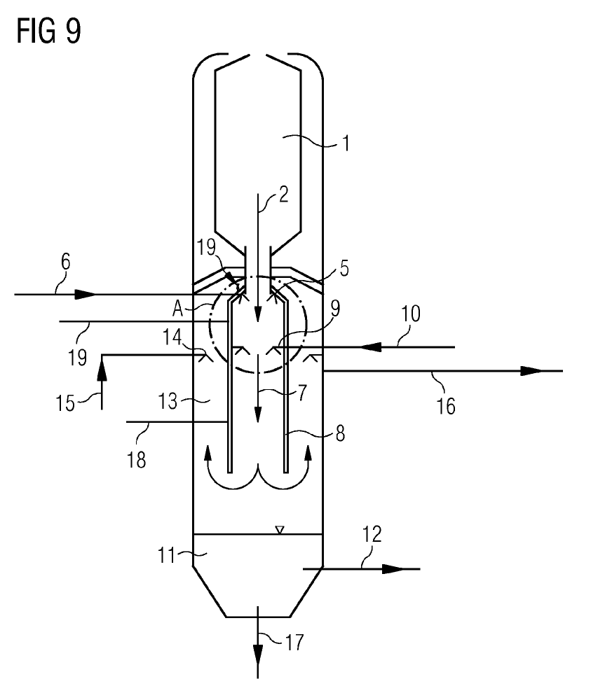

Variant 5 is shown in FIG. 9. The hot raw gas and the molten slag are guided out of the reactor (1) via the slag drain body (3) into the quench zone (7). The quench zone (7) is bounded by the central tube (8). The latter has a twin shell (8) cooled with water. This cooling water is taken from an external cooling circuit. FIG. 9 shows a feed stub (18) and two drain stubs (19). The ultimate number is dependent on the geometry of the immersed tube (8) and construction-related boundary conditions. The heat removed has to be released again by means of a suitable heat transfer process. The quenching and subsequent process regime correspond to variant 4.

The present invention has been elucidated in detail for illustration purposes using specific working examples. Elements of the individual working examples may also be combined with one another. The invention is therefore not supposed to be limited to individual working examples, but merely to experience restriction by the appended claims.

### LIST OF REFERENCE NUMERALS FOR OPEN AND CLOSED CENTRAL TUBE, VARIANTS 1 TO 3

1 Reactor
2 Hot raw gas with molten slag
3 Slag drain body
4 Self-cooling quench tube (conical)
5 Quenching nozzles
6 Supply of self-cooling quench tube with quenching water
7 Quench zone (over the entire central tube)
8 Self-cooling central tube (immersion possible, variant 2)
9 Scrubbing nozzles of central tube
10 Supply of self-cooling central tube with scrubbing water
11 Quencher bottom
12 Black water removal
13 Outer ring space with countercurrent scrubbing
14 Washing nozzles for countercurrent scrubbing
15 Supply of scrubbing nozzles for countercurrent scrubbing
16 Crude gas exit
17 Slag exit
18 Gap between slag drain body and central tube

### LIST OF REFERENCE NUMERALS FOR SELF-CONTAINED CENTRAL TUBE, VARIANT 4

1 Reactor
2 Hot raw gas with molten slag
3 Slag drain body
4
5 Quenching nozzles
6 Supply of self-cooling quench tube with quenching water
7 Quench zone (over the entire central tube)
8 Self-cooling central tube
9 Scrubbing nozzles of central tube
10 Supply of self-cooling central tube with scrubbing water
11 Quencher bottom
12 Black water removal
13 Outer ring space with countercurrent scrubbing
14 Washing nozzles for countercurrent scrubbing
15 Supply of scrubbing nozzles for countercurrent scrubbing
16 Crude gas exit
17 Slag exit
18 Replenishment of the central tube with cooling water
19 Drain valve

### LIST OF REFERENCE NUMERALS FOR SELF-CONTAINED CENTRAL TUBE WITH COOLING CIRCUIT, VARIANT 5

1 Reactor
2 Hot raw gas with molten slag
3 Slag drain body
4
5 Quenching nozzles
6 Supply of self-cooling quench tube with quenching water
7 Quench zone (over the entire central tube)
8 Self-cooling central tube
9 Scrubbing nozzles of central tube
10 Supply of self-cooling central tube with scrubbing water
11 Quencher bottom
12 Black water removal
13 Outer ring space with countercurrent scrubbing
14 Washing nozzles for countercurrent scrubbing
15 Supply of scrubbing nozzles for countercurrent scrubbing
16 Crude gas exit
17 Slag exit
18 Quench water feed for cooling of the central and quench tube with quenching water
19 Quench water drain for cooling of the central and quench tube with quenching water

1. A raw gas quenching system in an entrained flow gasification unit for the reaction of ash-containing fuels with a free oxygen-containing gasifying composition to give a raw gas having a high hydrogen content, comprising:
a gasification reactor in which fuel is converted, at temperatures of 1200 to 1900° C. and process pressures up to 10 MPa, to raw gas and liquid slag, a quencher,
a gas and slag outlet through which the raw gas and the liquid slag are transferred into the quencher beneath the gasification reactor,
a water bath at the lower end of the quencher,
a central tube which adjoins the gas and slag outlet, wherein the central tube has an upper quenching water shell through which quenching water flows and a lower scrubbing water shell through which scrubbing water flows,
quenching nozzles disposed in the quenching water shell which inject quenching water from the quenching water shell into the raw gas and slag stream,
scrubbing nozzles disposed in the scrubbing water shell which inject scrubbing water from the scrubbing water shell into the raw gas and slag stream, and
a raw gas outlet disposed in a pressure shell of the quencher from which the raw gas leaves the quencher.

2. The raw gas quenching system as claimed in claim 1, further comprising:
scrubbing nozzles, wherein the raw gas, on its way between the surface of the water bath and the raw gas outlet, is sprayed with scrubbing water by the scrubbing nozzles.

3. The raw gas quenching system as claimed in claim 2,
wherein the scrubbing nozzles are disposed above the raw gas outlet.

4. The raw gas quenching system as claimed in claim 1,
wherein the lower end of the central tube is not immersed into the water bath and the raw gas above the surface of the water bath ascends deflected outside the central tube.

5. The raw gas quenching system as claimed in claim 1,
wherein the lower end of the central tube is immersed into the water bath and the raw gas ascends in a bubble column outside the central tube.

6. The raw gas quenching system as claimed in claim 1,
wherein the central tube is connected to the gas and slag outlet in a gastight manner.

7. The raw gas quenching system as claimed in claim 1,
wherein a gap is left between the gas and slag outlet and the central tube.
